(19) United States
(12) Patent Application Publication
(10) Pub. No.: US 2023/0383211 A1
(43) Pub. Date: Nov. 30, 2023

(54) ENGINE OIL FORMLUATION FOR CONTROLLING PARTICULATE EMISSIONS

(71) Applicant: AFTON CHEMICAL CORPORATION, Richmond, VA (US)

(72) Inventors: Huifang Shao, Moseley, VA (US); Joseph Remias, Glen Allen, VA (US); Joseph W. Roos, Mechanicsville, VA (US); Gregory Guinther, Richmond, VA (US)

(21) Appl. No.: 17/825,532

(22) Filed: May 26, 2022

(51) Int. Cl. C10M 135/10; C10M 169/04

(52) U.S. Cl. CPC C10M 135/10; C10M 169/04; C10M 2203/003; C10M 2219/046; C10N 2030/40

(57) ABSTRACT

Methods of reducing particulate emissions from a gasoline engine by lubricating the gasoline engine with select calcium and magnesium-based lubricating oil compositions.

### FIELD

The present disclosure relates to methods of reducing particulate emissions from gasoline engines and, in particular, methods of reducing particulate emissions from gasoline engines lubricated with select lubricating compositions.

### BACKGROUND

Vehicle emissions standards are often closely examined worldwide by regulatory and/or environmental groups. Standards are being set to continuously lower various types of emissions. In some cases, vehicle particulate emission limits are being reduced and now include limits for particulate emissions from gasoline/spark-ignition engines as well as other engine technologies. In the gasoline or spark-ignition engines, the reduced limits for particulate emissions are sometimes solved, in-part, with improving vehicle hardware design. For instance, attention may be being given to injection technology to improve combustion leading to reduced emissions. If not optimized, however, injector coking can lead to unfavorable fuel spray and increased particulate emissions.

Conventional stoichiometric gasoline engines generally have low particulate emissions; however, gasoline engines in some instances may have increased particulate emissions depending on the engine type, fuel compositions, engine configuration, and/or a number of other factors. A gasoline particulate filter (GPF) can be used, in some instances, for engines to reduce particulate emission, but particulate emission can still be affected by many factors, including filter age and/or performance, fuel composition, and/or engine characteristics, age, or settings. Thus, even for gasoline engines or even gasoline engines equipped with GPF, the fluid properties may still have meaningful impact on tailpipe emissions.

### SUMMARY

Disclosed herein are methods of reducing particulate emissions from a gasoline engine. In embodiments, the method includes combusting a gasoline composition in a gasoline engine, wherein the gasoline engine is lubricated with a lubricating composition including at least about 1500 ppm of calcium and no more than about 500 ppm of magnesium.

In other embodiments of the methods, optional features, method steps, and/or limitations may be combined in any combination. Such optional features, method steps, or limitations of the method may include one or more of the following: wherein a weight ratio of calcium to magnesium provided by detergent additives in the lubricating composition is about 10:1 to about 300:1; and/or wherein the particulate emissions from combustion of the gasoline composition in the gasoline engine, as measured by particle numbers, is reduced as compared to particulate emissions as measured by particle numbers from combustion of the gasoline composition in the gasoline engine when lubricated with a lubricating composition having a mixed calcium and magnesium metal composition with a weight ratio of calcium to magnesium provided by detergent additives of about 2:1 to less than about 10:1, and wherein particle number is measured during the combustion of the gasoline composition pursuant to the US06 Drive Cycle; and/or wherein the gasoline engine is equipped with a gasoline particulate filter and the particulate emissions are reduced after one US06 Drive Cycle independent of any prior ash and/or soot accumulation of the gasoline particulate filter; and/or the method further includes measuring particulate emissions as particle number while performing an US06 Drive Cycle; and/or wherein particle number is measured pursuant to the Golden Particle Measurement System (GPMS); and/or wherein the gasoline engine is a hybrid-electric engine equipped with a gasoline particulate filter; and/or wherein the lubricating composition includes about 1,800 ppm to about 3,000 ppm of calcium and about 10 ppm to about 100 ppm of magnesium; and/or wherein the lubricating composition includes about 3,000 ppm to about 5,000 ppm of total minerals and wherein about 40 weight percent to about 60 weight percent of the total minerals is the calcium and no more than about 1 weight percent of the total minerals is the magnesium; and/or wherein the total minerals of the lubricating composition further include minerals selected from molybdenum, phosphorus, zinc, boron, or combinations thereof; and/or wherein the total minerals of the lubricating composition includes about 1 weight percent to about 5 weight percent of molybdenum, about 15 weight percent to about 15 weight percent of phosphorus, about 15 weight percent to about 30 weight percent of zinc, and/or about 1 weight percent to about 10 weight percent of boron; and/or wherein the lubricating composition further includes one or more additives selected from viscosity index improvers, dispersants, antifoam additives, antioxidants, antiwear additives, friction modifiers, pour point dispersants, detergents, or combinations thereof; and/or wherein the calcium is provided by one or more of a neutral to overbased calcium sulfonate, calcium phenate, or calcium salicylate; and/or wherein the calcium is provided by an overbased calcium sulfonate having a total base number of 200 mg to 500 mg KOH/g; and/or wherein the magnesium is provided by detergent additives selected from magnesium sulfonate, magnesium phenate, and magnesium salicylate; and/or wherein the gasoline composition includes about 10 ppm to about 200 ppm of a Mannich detergent; and/or further comprising measuring particle number throughout one US06 drive cycle; and/or wherein the gasoline engine is equipped with a gasoline particulate filter; and/or wherein the lubricating composition includes at least about 1,800 ppm of calcium and no more than about 100 ppm of magnesium; and/or wherein the lubricating composition includes at least about 2,000 ppm of calcium and no more than about 50 ppm of magnesium; and/or wherein the lubricating composition includes at least about 2,000 ppm of calcium and no more than about 25 ppm of magnesium; and/or wherein a weight ratio of calcium to magnesium provided by detergent additives in the lubricating composition is about 150:1 to about 300:1.

### BRIEF DESCRIPTION OF THE DRAWINGS

FIG. 1 is a graph of vehicle speed throughout a test protocol based on the EPA supplemental FTP driving cycle—US06.

FIG. 2 is a graph of instantaneous particle number, vehicle speed, and cumulative fuel economy for an inventive method within a US06 drive cycle test protocol.

FIG. 3 is a bar graph of particle number for several US06 drive cycles comparing inventive methods to mixed calcium/magnesium comparative methods; and

FIG. 4 is a statistical box plot of particle number.

### DETAILED DESCRIPTION

In the present disclosure, mineral and/or metal contents of lubricating compositions were evaluated for impact on the tailpipe particulate emissions of gasoline engines and gasoline engines including gasoline particulate filters (GPF) using a series of standard vehicle testing drive cycles such as, but not limited to, the US06 Drive Cycle (or equivalent). Surprisingly, it was discovered that emissions quality in terms of particulate number can be improved in such drive cycle testing instantaneously as an effect of select compositions of the lubricant chemistry used to lubricant the gasoline engine. Such instantaneous emission improvement would not be expected due to the short time for contact with any lubricant chemistry with the engine or fuel, due to limited ash accumulation in a filter, if included in the vehicle, and/or due to a small amount of contact between the lubricant and fuel for transfer of lubricant components to the combustion chamber to provide any effect during a drive cycle test. Despite the short testing time, select engine lubricant formulations that included specific calcium and magnesium lubricant compositions unexpectedly improved tailpipe emissions in terms of particulate number regardless of the presence of a GPF, the pre-existing condition of the GPF, and/or condition of the three-way catalyst (TWC) for the GPF.

In one approach or embodiment, methods are described herein for reducing particulate emissions from a gasoline engine, such as a port injection or a direct injection gasoline engine with or without a gasoline particulate filter (GPF), by combusting a gasoline composition in the gasoline engine and where the gasoline engine is lubricated with a lubricating composition including a select calcium and magnesium mineral profile with at least about 1500 ppm of calcium and a magnesium-depleted mineral profile with no more than about 500 ppm of magnesium. The lubricating composition may have a weight ratio of calcium-to-magnesium provided by detergent additives in the lubricating composition of about 10:1 to about 300:1 and wherein the particulate emissions from combustion of the gasoline composition in the gasoline engine, as measured by particle number, is reduced as compared to particulate emissions as measured by particle number from combustion of the gasoline composition in the gasoline engine when lubricated with a lubricating composition having a mixed calcium and magnesium metal composition with a weight ratio of calcium-to-magnesium provided by detergent additives of about 2:1 to less than about 10:1. Preferably, particle number is measured during the combustion of the gasoline composition pursuant to the US06 Drive Cycle (or equivalent) and where particle number is measured pursuant to the Golden Particle Measurement System (GPMS) or equivalent measurement scheme. The US06 Supplemental Federal Test Procedure (SFTP) used herein was developed by the EPA to address possible shortcomings with the FTP-75 test cycle in the representation of aggressive, high speed, and/or high acceleration driving behavior, rapid speed fluctuations, and driving behavior following startup.

In further approaches or embodiments, the select calcium and magnesium lubricating compositions to reduce tailpipe emissions herein may include at least about 1,500 ppm of calcium or about 1,800 ppm to about 3,000 ppm of calcium and less than about 500 ppm of magnesium or less than 100 ppm of magnesium (such as, about 10 ppm to about 100 ppm of magnesium), or the lubricating composition may include about 3,000 ppm to about 5,000 ppm of total minerals (including metals and other minerals as defined below) and wherein about 40 weight percent to about 60 weight percent of the total minerals is the calcium and no more than about 1 weight percent (preferably, no more than about 0.5 weight percent, and more preferably, no more than 0.25 weight percent) of the total minerals is the magnesium. The total minerals in the lubricating compositions to reduce tailpipe emissions may include (in addition to calcium and the residual levels of magnesium) minerals selected from the metals of molybdenum and/or zinc as well as other minerals including phosphorus and/or boron or any combinations of such minerals and metals. For instance and in some approaches, the total minerals of the lubricating composition for reducing tailpipe emissions includes about 1 weight percent to about 5 weight percent of molybdenum, about 15 weight percent to about 15 weight percent of phosphorus, about 15 to about 30 weight percent of zinc, and about 1 weight percent to about 10 weight percent of boron in addition to the above described calcium and magnesium (with weight percent based on the total amount of minerals). If needed, the lubricating compositions may further include one or more other additives selected from viscosity index improvers, dispersants, antifoam additives, antioxidants, antiwear additives, friction modifiers, pour point dispersants, detergents, or combinations thereof.

Discovered herein are select calcium and magnesium lubricating compositions that result in methods of instantaneous emissions improvements in the context of the US06 driving cycle tests when lubricating gasoline engines. As discussed more below, the inventive lubricating compositions have at least about 1500 ppm of calcium, at least about 1800 ppm of calcium, or at least about 2000 ppm of calcium and no more than 500 ppm of magnesium, no more than 200 ppm of magnesium, no more than 100 ppm of magnesium, no more than 50 ppm of magnesium, no more than 25 ppm of magnesium, no more than 15 ppm of magnesium, no more than 10 ppm of magnesium with ratios of the calcium-to-magnesium ranging from greater than about 10:1 to about 300:1 or, in other approaches, about 150:1 to about 300:1, or about 200:1 to about 300:1 (or any other ranges within such noted endpoints). Preferably, calcium is provided by detergent additives in the lubricant composition, such as neutral to overbased calcium sulfonate, calcium phenate, and/or calcium salicylate. Magnesium, if present, may also be provided by detergent additives including magnesium sulfonate, magnesium phenate, and/or magnesium salicylate. Suitable lubricating compositions are discussed further below.

As discussed more in the examples below, a testing protocol was developed using the US06 Drive Cycle as a base and included a cold start (after 8 hours soak or, preferably, an overnight soak) followed by a number of US06 drive cycles with warm starts (one hour soak) between each subsequent cycle. Each test takes approximately 6 hours. A double oil flush was conducted when oil needed changing for testing. Emissions is measured by particle number as measured pursuant to the Golden Particle Measurement System (GPMS) or equivalent and, in some circumstances, an instantaneous particle number measurement through each drive cycle when lubricating the engine with the select lubricants herein has no greater than 1.5×10⁷ particles with a size between about 20 nm and about 4 μm per cubic centimeter. Suitable measurement equipment may be an engine exhaust condensation particle counter (EECPC), model 3790 or equivalent (TSI Incorporated) and/or an engine exhaust particle sizer (EEPS), model 3090 or equivalent (TSI Incorporated).

Hydrocarbon Fuel

By “fuels” herein is meant one or more hydrocarbon fuels suitable for use in the operation of combustion systems including gasolines, unleaded motor and aviation gasolines, and so-called reformulated gasolines which typically contain both hydrocarbons of the gasoline boiling range and fuel-soluble oxygenated blending agents, such as alcohols, ethers and other suitable oxygen-containing organic compounds. Suitable fuels include leaded or unleaded motor gasolines, and so-called reformulated gasolines which typically contain both hydrocarbons of the gasoline boiling range and fuel-soluble oxygenated blending agents (“oxygenates”), such as alcohols, ethers and other suitable oxygen-containing organic compounds. Preferably, the fuel is a mixture of hydrocarbons boiling in the gasoline boiling range. This fuel may consist of straight chain or branch chain paraffins, cycloparaffins, olefins, aromatic hydrocarbons or any mixture of these. The gasoline can be derived from straight run naphtha, polymer gasoline, and natural gasoline or from catalytically reformed stocks boiling in the range from about 80° to about 450° F. The octane level of the gasoline is not critical and any conventional gasoline may be employed in the practice of this invention.

Oxygenates suitable for use include methanol, ethanol, isopropanol, t-butanol, mixed C₁ to C₅ alcohols, methyl tertiary butyl ether, tertiary amyl methyl ether, ethyl tertiary butyl ether and mixed ethers. Oxygenates, when used, may be present in the base fuel in an amount up to about 90% by volume, and preferably only up to about 25% by volume.

The fuels may include a wide variety of additives as needed for a particular application and may include octane enhancers, detergents, and the like additives. Octane enhancers include both organometallic octane enhancers and other octane enhancers generally. These other octane enhancers include ethers and aromatic amines.

One group of organometallic octane enhancers may contain manganese. Examples of manganese containing organometallic compounds are manganese tricarbonyl compounds. Suitable manganese tricarbonyl compounds which can be used include cyclopentadienyl manganese tricarbonyl, methylcyclopentadienyl manganese tricarbonyl, dimethylcyclo pentadienyl manganese tricarbonyl, trimethylcyclopentadienyl manganese tricarbonyl, tetramethylcyclopentadienyl manganese tricarbonyl, pentamethylcyclopentadienyl manganese tricarbonyl, ethylcyclopentadienyl manganese tricarbonyl, diethyl cyclopentadienyl manganese tricarbonyl, propylcyclopentadienyl manganese tricarbonyl, isopropylcyclopentadienyl manganese tricarbonyl, tert-butylcyclopentadienyl manganese tricarbonyl, octylcyclopentadienyl manganese tricarbonyl, dodecylcyclopentadienyl manganese tricarbonyl, ethylmethyl cyclopentadienyl manganese tricarbonyl, indenyl manganese tricarbonyl, and the like, including mixtures of two or more such compounds. In one example are the cyclopentadienyl manganese tricarbonyls which are liquid at room temperature such as methylcyclopentadienyl manganese tricarbonyl, ethylcyclopentadienyl manganese tricarbonyl, liquid mixtures of cyclopentadienyl manganese tricarbonyl and methylcyclopentadienyl manganese tricarbonyl, mixtures of methylcyclopentadienyl manganese tricarbonyl and ethyl cyclopentadienyl manganese tricarbonyl, etc.

Another example of a group of organometallic octane enhancers is a group that contains iron. These iron-containing compounds include ferrocene.

Nitrate octane enhancers (also frequently known as ignition improvers) comprise nitrate esters of substituted or unsubstituted aliphatic or cycloaliphatic alcohols which may be monohydric or polyhydric. The organic nitrates may be substituted or unsubstituted alkyl or cycloalkyl nitrates having up to about ten carbon atoms, for example from two to ten carbon atoms. The alkyl group may be either linear or branched (or a mixture of linear and branched alkyl groups). Specific examples of nitrate compounds suitable for use as nitrate combustion improvers include, but are not limited to the following: methyl nitrate, ethyl nitrate, n-propyl nitrate, isopropyl nitrate, allyl nitrate, n-butyl nitrate, isobutyl nitrate, sec-butyl nitrate, tert-butyl nitrate, n-amyl nitrate, isoamyl nitrate, 2-amyl nitrate, 3-amyl nitrate, tert-amyl nitrate, n-hexyl nitrate, n-heptyl nitrate, sec-heptyl nitrate, n-octyl nitrate, 2-ethylhexyl nitrate, sec-octyl nitrate, n-nonyl nitrate, n-decyl nitrate, cyclopentylnitrate, cyclohexyl nitrate, methylcyclohexyl nitrate, isopropylcyclohexyl nitrate, and the like. Also suitable are the nitrate esters of alkoxy substituted aliphatic alcohols such as 2-ethoxyethyl nitrate, 2-(2-ethoxyethoxy) ethyl nitrate, 1-methoxypropyl-2-nitrate, and 4-ethoxybutyl nitrate, as well as diol nitrates such as 1,6-hexamethylene dinitrate and the like. For example the alkyl nitrates and dinitrates having from five to ten carbon atoms, and most especially mixtures of primary amyl nitrates, mixtures of primary hexyl nitrates, and octyl nitrates such as 2-ethylhexyl nitrate are also included.

Other supplemental additives may also include dispersants/detergents, antioxidants, carrier fluids, metal deactivators, dyes, markers, corrosion inhibitors, biocides, antistatic additives, drag reducing agents, demulsifiers, emulsifiers, dehazers, anti-icing additives, antiknock additives, anti-valve-seat recession additives, lubricity additives, surfactants, combustion improvers, and mixtures thereof.

One type of detergent is a Mannich base detergent. Suitable Mannich base detergents for use in the fuel compositions herein include the reaction products of a high molecular weight alkyl-substituted hydroxyaromatic compound, aldehydes and amines. If used, the fuel composition may include about 10 to about 1000 ppm of a Mannich base detergent (preferably, about 10 to about 200 ppm or, more preferably, about 45 to about 200 ppm).

In one approach, the high molecular weight alkyl substituents on the benzene ring of the hydroxyaromatic compound may be derived from a polyolefin having a number average molecular weight (Mn) from about 500 to about 3000, preferably from about 700 to about 2100, as determined by gel permeation chromatography (GPC) using polystyrene as reference. The polyolefin may also have a polydispersity (weight average molecular weight/number average molecular weight) of about 1 to about 4 (in other instances, about 1 to about 2) as determined by GPC using polystyrene as reference.

The alkylation of the hydroxyaromatic compound is typically performed in the presence of an alkylating catalyst at a temperature in the range of about 0 to about 200° C., preferably 0 to 100° C. Acidic catalysts are generally used to promote Friedel-Crafts alkylation. Typical catalysts used in commercial production include sulphuric acid, BF₃, aluminum phenoxide, methanesulphonic acid, cationic exchange resin, acidic clays and modified zeolites.

Polyolefins suitable for forming the high molecular weight alkyl-substituted hydroxyaromatic compounds include polypropylene, polybutenes, polyisobutylene, copolymers of butylene and/or butylene and propylene, copolymers of butylene and/or isobutylene and/or propylene, and one or more mono-olefinic comonomers copolymerizable therewith (e.g., ethylene, 1-pentene, 1-hexene, 1-octene, 1-decene, etc.) where the copolymer molecule contains at least 50% by weight, of butylene and/or isobutylene and/or propylene units. The comonomers polymerized with propylene or such butenes may be aliphatic and can also contain non-aliphatic groups, e.g., styrene, o-methylstyrene, p-methylstyrene, divinyl benzene and the like. Thus in any case the resulting polymers and copolymers used in forming the high molecular weight alkyl-substituted hydroxyaromatic compounds are substantially aliphatic hydrocarbon polymers.

Polybutylene is preferred. Unless otherwise specified herein, the term “polybutylene” is used in a generic sense to include polymers made from “pure” or “substantially pure” 1-butene or isobutene, and polymers made from mixtures of two or all three of 1-butene, 2-butene and isobutene. Commercial grades of such polymers may also contain insignificant amounts of other olefins. So-called high reactivity polyisobutenes having relatively high proportions of polymer molecules having a terminal vinylidene group are also suitable for use in forming the long chain alkylated phenol reactant. Suitable high-reactivity polyisobutenes include those polyisobutenes that comprise at least about 20% of the more reactive methylvinylidene isomer, preferably at least 50% and more preferably at least 70%. Suitable polyisobutenes include those prepared using BF₃ catalysts. The preparation of such polyisobutenes in which the methylvinylidene isomer comprises a high percentage of the total composition is described in U.S. Pat. Nos. 4,152,499 and 4,605,808, which are both incorporated herein by reference.

The Mannich detergent may be made from a high molecular weight alkylphenol or alkylcresol. However, other phenolic compounds may be used including high molecular weight alkyl-substituted derivatives of resorcinol, hydroquinone, catechol, hydroxydiphenyl, benzylphenol, phenethylphenol, naphthol, tolylnaphthol, among others. Preferred for the preparation of the Mannich detergents are the polyalkylphenol and polyalkylcresol reactants, e.g., polypropylphenol, polybutylphenol, polypropylcresol and polybutylcresol, wherein the alkyl group has a number average molecular weight of about 500 to about 2100 as measured by GPC using polystyrene as reference, while the most preferred alkyl group is a polybutyl group derived from polyisobutylene having a number average molecular weight in the range of about 700 to about 1300 as measured by GPC using polystyrene as reference.

The preferred configuration of the high molecular weight alkyl-substituted hydroxyaromatic compound is that of a para-substituted mono-alkylphenol or a para-substituted mono-alkyl ortho-cresol. However, any hydroxyaromatic compound readily reactive in the Mannich condensation reaction may be employed. Thus, Mannich products made from hydroxyaromatic compounds having only one ring alkyl substituent, or two or more ring alkyl substituents are suitable for use in this invention. The long chain alkyl substituents may contain some residual unsaturation, but in general, are substantially saturated alkyl groups.

Representative amine reactants include, but are not limited to, alkylene polyamines having at least one suitably reactive primary or secondary amino group in the molecule. Other substituents such as hydroxyl, cyano, amido, etc., can be present in the polyamine. In a preferred embodiment, the alkylene polyamine is a polyethylene polyamine. Suitable alkylene polyamine reactants include ethylenediamine, diethylenetriamine, triethylenetetramine, tetraethylene pentamine and mixtures of such amines having nitrogen contents corresponding to alkylene polyamines of the formula H₂N-(A-NH—)ₙH, where A in this formula is divalent ethylene or propylene and n is an integer of from 1 to 10, preferably 1 to 4. The alkylene polyamines may be obtained by the reaction of ammonia and dihalo alkanes, such as dichloro alkanes.

The amine may also be an aliphatic diamine having one primary or secondary amino group and at least one tertiary amino group in the molecule. Examples of suitable polyamines include N,N,N″,N″-tetraalkyldialkylenetriamines (two terminal tertiary amino groups and one central secondary amino group), N,N,N′,N″-tetraalkyltrialkylenetetramines (one terminal tertiary amino group, two internal tertiary amino groups and one terminal primary amino group), N,N,N′,N″,N′″-pentaalkyltrialkylenetetramines (one terminal tertiary amino group, two internal tertiary amino groups and one terminal secondary amino group), N,N-dihydroxyalkyl-alpha-, omega-alkylenediamines (one terminal tertiary amino group and one terminal primary amino group), N,N,N′-trihydroxyalkyl-alpha, omega-alkylenediamines (one terminal tertiary amino group and one terminal secondary amino group), tris(dialkylaminoalkyl)aminoalkylmethanes (three terminal tertiary amino groups and one terminal primary amino group), and similar compounds, wherein the alkyl groups are the same or different and typically contain no more than about 12 carbon atoms each, and which preferably contain from 1 to 4 carbon atoms each. Most preferably these alkyl groups are methyl and/or ethyl groups. Preferred polyamine reactants are N,N-dialkyl-alpha, omega-alkylenediamine, such as those having from 3 to about 6 carbon atoms in the alkylene group and from 1 to about 12 carbon atoms in each of the alkyl groups, which most preferably are the same but which can be different. Most preferred is N,N-dimethyl-1,3-propanediamine and N-methyl piperazine.

Examples of polyamines having one reactive primary or secondary amino group that can participate in the Mannich condensation reaction, and at least one sterically hindered amino group that cannot participate directly in the Mannich condensation reaction to any appreciable extent include N-(tert-butyl)-1,3-propanediamine, N-neopentyl-1,3-propanediamine-, N-(tert-butyl)-1-methyl-1,2-ethanediamine, N-(tert-butyl)-1-methyl-1,3-propanediamine, and 3,5-di(tert-butyl)aminoethylpiperazine.

Representative aldehydes for use in the preparation of the Mannich base products include the aliphatic aldehydes such as formaldehyde, acetaldehyde, propionaldehyde, butyraldehyde, valeraldehyde, caproaldehyde, heptaldehyde, stearaldehyde. Aromatic aldehydes which may be used include benzaldehyde and salicylaldehyde. Illustrative heterocyclic aldehydes for use herein are furfural and thiophene aldehyde, etc. Also useful are formaldehyde-producing reagents such as paraformaldehyde, or aqueous formaldehyde solutions such as formalin. Most preferred is formaldehyde or formalin.

The condensation reaction among the alkylphenol, the specified amine(s) and the aldehyde may be conducted at a temperature typically in the range of about 40° C. to about 200° C. The reaction can be conducted in bulk (no diluent or solvent) or in a solvent or diluent. Water is evolved and can be removed by azeotropic distillation during the course of the reaction. Typically, the Mannich reaction products are formed by reacting the alkyl-substituted hydroxyaromatic compound, the amine and aldehyde in the molar ratio of 1.0:0.5-2.0:1.0-3.0, respectively.

Suitable Mannich base detergents include those detergents taught in U.S. Pat. Nos. 4,231,759; 5,514,190; 5,634,951; 5,697,988; 5,725,612; and 5,876,468, the disclosures of which are incorporated herein by reference.

Another suitable additional fuel additive may be a hydrocarbyl amine detergents. If used, the fuel composition may include about 45 to about 1000 ppm of the hydrocarbyl amine detergent. One common process involves halogenation of a long chain aliphatic hydrocarbon such as a polymer of ethylene, propylene, butylene, isobutene, or copolymers such as ethylene and propylene, butylene and isobutylene, and the like, followed by reaction of the resultant halogenated hydrocarbon with a polyamine. If desired, at least some of the product can be converted into an amine salt by treatment with an appropriate quantity of an acid. The products formed by the halogenation route often contain a small amount of residual halogen such as chlorine. Another way of producing suitable aliphatic polyamines involves controlled oxidation (e.g., with air or a peroxide) of a polyolefin such as polyisobutene followed by reaction of the oxidized polyolefin with a polyamine. For synthesis details for preparing such aliphatic polyamine detergent/dispersants, see for example U.S. Pat. Nos. 3,438,757; 3,454,555; 3,485,601; 3,565,804; 3,573,010; 3,574,576; 3,671,511; 3,746,520; 3,756,793; 3,844,958; 3,852,258; 3,864,098; 3,876,704; 3,884,647; 3,898,056; 3,950,426; 3,960,515; 4,022,589; 4,039,300; 4,128,403; 4,166,726; 4,168,242; 5,034,471; 5,086,115; 5,112,364; and 5,124,484; and published European Patent Application 384,086. The disclosures of each of the foregoing documents are incorporated herein by reference. The long chain substituent(s) of the hydrocarbyl amine detergent most preferably contain(s) an average of 40 to 350 carbon atoms in the form of alkyl or alkenyl groups (with or without a small residual amount of halogen substitution). Alkenyl substituents derived from poly-alpha-olefin homopolymers or copolymers of appropriate molecular weight (e.g., propene homopolymers, butene homopolymers, C3 and C4 alpha-olefin copolymers, and the like) are suitable. Most preferably, the substituent is a polyisobutenyl group formed from polyisobutene having a number average molecular weight (as determined by gel permeation chromatography) in the range of 500 to 2000, preferably 600 to 1800, most preferably 700 to 1600.

Polyetheramines are yet another suitable additional detergent chemistry used in the methods of the present disclosure. If used, the fuel composition may include about 45 to about 1000 ppm of the polyetheramine detergents. The polyether backbone in such detergents can be based on propylene oxide, ethylene oxide, butylene oxide, or mixtures of these. The most preferred are propylene oxide or butylene oxide or mixture thereof to impart good fuel solubility. The polyetheramines can be monoamines, diamines or triamines. Examples of commercially available polyetheramines are those under the tradename Jeffamines™ available from Huntsman Chemical company and the poly(oxyalkylene)carbamates available from Chevron Chemical Company. The molecular weight of the polyetheramines will typically range from 500 to 3000. Other suitable polyetheramines are those compounds taught in U.S. Pat. Nos. 4,191,537; 4,236,020; 4,288,612; 5,089,029; 5,112,364; 5,322,529; 5,514,190 and 5,522,906.

Internal Combustion Engines:

The methods using the select calcium and magnesium-based lubricating oil compositions herein may be suitable for various engine types, such as but not limited to, hybrid gasoline-electric engines, port-fuel injected engines, gasoline direct injection (GDI) and/or gasoline direct injection engines or other gasoline engines with gasoline particulate filters. The gasoline engine may be a spark-ignited engine. An internal combustion engine may also be used in combination with an electrical or battery source of power. An engine so configured is commonly known as a hybrid engine. The internal combustion engine may be a 2-stroke, 4-stroke, or rotary engine.

Any of the engines herein may also include a gasoline particulate filter (GPF). GPFs are effective for reducing particulate emissions, in some configurations, once operating in cake filtration mode after a soot cake has developed in the filter. GPFs may optionally be coated with a three-way catalyst (TWC). The present disclosure relates to both uncoated and coated GPFs. As well known, a problem with GDI technology is that newly installed gasoline particulate filters (GPFs) have a low filtration efficiency for a period of time when operating in bed filtration mode prior to sufficient particle build-up in the pores of the GPF to permit operation in cake filtration mode. Fresh GPF filtration efficiency can be as low as 30%. This low initial filtration efficiency will affect the emission performance. The GPF filter mechanism has two primary filtration modes: bed filtration and cake filtration. At the early stage of GPF use, particles will be trapped first in the pores of the GPF in a process called bed filtration. This stage of filtration is characterized by relatively low filtration efficiency and rapid increase in back pressure. As particles continue to enter the GPF, the filtration media pores are filled with particulate matter to produce a filtration cake, leading to a transition from bed filtration mode to cake filtration mode once the particles deposit along the channel wall. Cake filtration will remain efficient until the filter reaches the threshold where the accumulated cake leads to significant backpressure rise due to channel blockage. However, this threshold is reached when the accumulated cake is sufficient to clog the filter, which usually occurs beyond the design service life for the filter.

Lubricating Oil Compositions:

The select calcium and magnesium lubricating oil compositions for reducing tailpipe emissions include a base oil of lubricating viscosity and a particular additive composition to provide, among other features, the noted calcium and magnesium levels. The methods of the present disclosure employ the select calcium and magnesium lubricating oil composition containing the additive composition when lubricating a gasoline. As described in more detail herein, the select calcium and magnesium lubricating oil composition may be surprisingly effective for instantaneously reducing particulate emissions when combusting gasoline in spark-ignition engines and, in some circumstances, improve emissions even with a GPF and, in some instances, aid in overcoming the initial poor performance of the filter.

The lubricating oil compositions for the methods herein have select calcium and magnesium amounts and relationships. In one embodiment, the disclosure provides a lubricating oil composition having greater than 50 weight percent of a base oil of lubricating viscosity, based on a total weight of the lubricating oil composition combined with a sufficient amount of one or more detergent additives to provide the select calcium and magnesium amounts and, optionally, the low magnesium minerals in the amounts and ratios discussed above to achieve the emissions reductions. In one approach, the detergent additives may include overbased calcium-containing detergents having a total base number of greater than 225 mg KOH/g, measured by the method of ASTM D-2896, to provide greater than about 1500 ppm calcium to the lubricating oil composition. In some approaches, the detergent additives are also depleted or have low levels of magnesium and, as such, may also include low/residual amounts of one or more overbased magnesium-containing detergents having a total base number of greater than 225 mg KOH/g, measured by the method of ASTM D-2896, wherein the total amount of magnesium provided by the one or more overbased magnesium detergents to the lubricating oil composition is no more than 500 ppm or other levels as noted herein.

The disclosure also provides a method for reducing tailpipe emissions, particularly reduced particulate emissions and improved GPF performance, in spark-ignition engines. In one approach, the methods herein includes a step of lubricating the spark-ignition internal combustion engine with the selected calcium and magnesium amounts in the lubricating oil compositions herein and operating the engine while lubricated with the lubricating oil composition whereby the particulate emissions from the engine are reduced as compared to an engine lubricated without the select calcium and magnesium based lubricating compositions herein. In some embodiments, the combustion chamber or cylinder walls of a spark-ignited direct injection engine or port fuel injected internal combustion engine is lubricated with the select calcium and magnesium lubricating oil composition during engine operation.

Optionally, the methods of the present disclosure may include a step of measuring the particulate emissions from combustion of the gasoline composition pursuant to US06 drive cycle when the engine is lubricated with the compositions herein. In such methods, a reduction of emission particle number may be a 15% or greater reduction, or a 20% or greater reduction, or a 30% or greater reduction (in other approaches, a 15% to 30% reduction). The emissions reductions are measured over an US06 drive cycle.

Detergents

The select calcium and magnesium based lubricating oil compositions herein include one or more overbased calcium detergents, such as calcium sulfonate, calcium salicylate, and/or calcium phenate detergents and may optionally include other detergents, such as one or more other metal overbased detergents and/or one or more low-based/neutral detergents to provide the noted calcium, magnesium, and other mineral levels. Suitable detergent substrates include phenates, sulfur containing phenates, sulfonates, calixarates, salixarates, salicylates, carboxylic acids, phosphorus acids, mono- and/or di-thiophosphoric acids, alkyl phenols, sulfur coupled alkyl phenol compounds, or methylene bridged phenols. Suitable detergents and their methods of preparation are described in greater detail in numerous patent publications, including U.S. Pat. No. 7,732,390 and references cited therein. The detergent substrate may be salted with an alkali or alkaline earth metal such as, but not limited to, calcium, magnesium, potassium, sodium, lithium, barium, or mixtures thereof. In some embodiments, the detergent may be free of barium. A suitable detergent may include alkali or alkaline earth metal salts of petroleum sulfonic acids and long chain mono- or di-alkylarylsulfonic acids with the aryl group being benzyl, tolyl, and xylyl.

Examples of suitable additional detergents include, but are not limited to, calcium phenates, calcium sulfur containing phenates, calcium sulfonates, calcium calixarates, calcium salixarates, calcium salicylates, calcium carboxylic acids, calcium phosphorus acids, calcium mono- and/or di-thiophosphoric acids, calcium alkyl phenols, calcium sulfur coupled alkyl phenol compounds, calcium methylene bridged phenols, magnesium phenates, magnesium sulfur containing phenates, magnesium sulfonates, magnesium calixarates, magnesium salixarates, magnesium salicylates, magnesium carboxylic acids, magnesium phosphorus acids, magnesium mono- and/or di-thiophosphoric acids, magnesium alkyl phenols, magnesium sulfur coupled alkyl phenol compounds, magnesium methylene bridged phenols, sodium phenates, sodium sulfur containing phenates, sodium sulfonates, sodium calixarates, sodium salixarates, sodium salicylates, sodium carboxylic acids, sodium phosphorus acids, sodium mono- and/or di-thiophosphoric acids, sodium alkyl phenols, sodium sulfur coupled alkyl phenol compounds, or sodium methylene bridged phenols.

Overbased detergents are well known in the art and may be alkali or alkaline earth metal overbased detergent. Such detergents may be prepared by reacting a metal oxide or metal hydroxide with a substrate and carbon dioxide gas. The substrate is typically an acid, for example, an acid such as an aliphatic substituted sulfonic acid, an aliphatic substituted carboxylic acid, or an aliphatic substituted phenol.

The terminology “overbased” relates to metal salts, such as metal salts of sulfonates, carboxylates, and phenates, wherein the amount of metal present exceeds the stoichiometric amount. Such salts may have a conversion level in excess of 100% (i.e., they may comprise more than 100% of the theoretical amount of metal needed to convert the acid to its “normal,” “neutral” salt). The expression “metal ratio,” often abbreviated as MR, is used to designate the ratio of total chemical equivalents of metal in the overbased salt to chemical equivalents of the metal in a neutral salt according to known chemical reactivity and stoichiometry. In a normal or neutral salt, the metal ratio is one and in an overbased salt, MR, is greater than one. They are commonly referred to as overbased, hyperbased, or superbased salts and may be salts of organic sulfur acids, carboxylic acids, or phenols.

An overbased detergent may have a TBN of greater 170 mg KOH/gram, or as further examples, a TBN of about 250 mg KOH/gram or greater, or a TBN of about 300 mg KOH/gram or greater, or a TBN of about 350 mg KOH/gram or greater, or a TBN of about 375 mg KOH/gram or greater, or a TBN of about 400 mg KOH/gram or greater, as determined using the method of ASTM D2896 (or any ranges between such TBN endpoints).

In any of the foregoing embodiments, the one or more overbased sulfonate detergents has a total base number of at least 225 mg KOH/g. In each of the foregoing embodiments, the one or more overbased sulfonate detergents may have a total base number of at least 250 mg KOH/g. In each of the foregoing embodiments, the one or more overbased sulfonate detergents may have a total base number of about 250 to about 450 mg KOH/g, or about 250 to about 350 mg KOH/g.

Examples of suitable overbased detergents include, but are not limited to, overbased calcium phenates, overbased calcium sulfur containing phenates, overbased calcium sulfonates, overbased calcium calixarates, overbased calcium salixarates, overbased calcium salicylates, overbased calcium carboxylic acids, overbased calcium phosphorus acids, overbased calcium mono- and/or di-thiophosphoric acids, overbased calcium alkyl phenols, overbased calcium sulfur coupled alkyl phenol compounds, overbased calcium methylene bridged phenols, overbased magnesium phenates, overbased magnesium sulfur containing phenates, overbased magnesium sulfonates, overbased magnesium calixarates, overbased magnesium salixarates, overbased magnesium salicylates, overbased magnesium carboxylic acids, overbased magnesium phosphorus acids, overbased magnesium mono- and/or di-thiophosphoric acids, overbased magnesium alkyl phenols, overbased magnesium sulfur coupled alkyl phenol compounds, or overbased magnesium methylene bridged phenols. The overbased detergent may have a metal to substrate ratio of from 1.1:1, or from 2:1, or from 4:1, or from 5:1, or from 7:1, or from 10:1.

In some approaches, the total amount of detergent may be present at up to 10 weight percent, or about up to 8 weight percent, up to about 4 weight percent, up to about 2.0 weight percent, or greater than about 1 weight percent, greater than about 1.2 weight percent, greater than about 1.4 weight percent or greater than about 1.1 weight percent to about 2.0 weight percent based on a total weight of the lubricating oil composition so long as the detergent satisfies the calcium and magnesium relationships set forth above. In other approaches, the total amount of detergent (and other additives) may be present in an amount to provide from about 1500 ppm to about 5000 ppm total metals and mineral content to the lubricating oil composition. In other embodiments, the detergent (and other additives) may provide from about 1500 ppm to about 4500 ppm of metal and/or mineral, or about 1800 ppm to about 4500 ppm of metal and/or mineral, or about 2000 ppm to about 4500 ppm of metal and or mineral to the lubricating oil composition herein and within the calcium and magnesium qualifiers set forth above to achieve the reduced particulate emissions. As discussed herein, total minerals from the detergent and other additives include molybdenum, phosphorus, zinc, boron, magnesium, and calcium.

In some approaches, the lubricating oil compositions of the present disclosure include at least one overbased calcium sulfonate detergent having a TBN of greater than 225 mg KOH/gram, in some approaches, greater than 250 mg KOH/gram, in other approaches, about 250 to about 400 mg KOH mg KOH/gram, and in yet other approaches, about 300 to about 400 mg KOH/gram (and having about 10 weight percent to about 15 weight percent calcium) and, in some approaches, an optional calcium phenate detergent having a TBN of greater than 170 mg KOH/gram, as determined by the method of ASTM-D2896 to provide the noted levels of calcium. The present disclosure also includes methods of using such lubricating oil compositions in a method or lubricating an engine by lubricating the engine with the lubricating oil composition and operating the engine.

The lubricating compositions herein may include a number of minerals from the detergent (and other additives) including, for instance, molybdenum, phosphorus, zinc, boron, magnesium, and calcium and may be calcium rich as discussed herein such that the minerals of the lubricating compositions includes at least 40 weight percent, based on the total minerals in the fluid, of calcium from the one or more overbased calcium detergents. In other approaches, the calcium may be about 40 weight percent to about 60 weight percent based on the total minerals in the lubricating oil compositions (or about 42 weight percent to about 58 weight percent, about 45 weight percent to about 55 weight percent, or about 50 weight percent to about 55 weight percent). In yet other approaches, the mineral of the lubricating compositions herein may also be depleted of or have low levels of magnesium, which means the minerals of the compositions include less than 1 percent of magnesium, less than 0.5 weight percent, less than about 0.25 weight percent and, may optionally, be devoid of magnesium based on the total minerals in the lubricant. In further approaches, the minerals of the lubricating compositions herein may further include about 1 weight percent to 5 weight percent of molybdenum, about 15 weight percent to about 20 weight percent of phosphorus, about 15 weight percent to about 30 weight percent of zinc, and/or about 1 weight percent to about 10 weight percent boron with all such minerals based on the total minerals of the lubricating composition (with the total mineral including molybdenum, phosphorus, zinc, born, magnesium, and calcium).

In other approaches, the lubricating compositions herein may include about 0.15 weight percent to about 0.3 weight percent calcium (in other approaches, about 0.2 weight percent to about 0.25 weight percent of calcium) and less than about 0.05 weight percent of magnesium (in other approaches, less than about 0.01 weight percent, less than about 0.005 weight percent, less than about 0.0025 weight percent, or less than about 0.01 weight percent magnesium). In further approaches, the lubricating compositions herein may also include about 0.005 weight percent to about 0.01 weight percent of molybdenum, about 0.05 weight percent to about 0.1 weight percent of phosphorus, about 0.05 weight percent to about 0.1 weight percent of zinc, and/or about 0.01 weight percent to about 0.05 weight percent boron.

In yet other approaches, the lubricating oil compositions of the disclosure may have a total amount of calcium from the overbased detergents that ranges from about 1500 ppm by weight to about 3000 ppm by weight based on a total weight of the lubricating oil composition, or amounts ranging from at least about 1500 ppm, at least about 1600 ppm, at least about 1700 ppm, at least about 1800 ppm, at least about 1900 ppm, at least about 2000 ppm, at least about 2100 ppm, at least about 2200 ppm to no more than 3000 ppm, no more than 2800 ppm, no more than 2700 ppm, no more than 2600 ppm, or no more than 2500 ppm of calcium.

The lubricating oil composition of the disclosure may optionally include another overbased detergent, which may be a small amount of an overbased magnesium-containing detergent. The overbased magnesium-containing detergent may be selected from an overbased magnesium sulfonate detergent, an overbased magnesium phenate detergent, and an overbased magnesium salicylate detergent. In certain embodiments, the overbased magnesium-containing detergent comprises an overbased magnesium sulfonate detergent. In certain embodiments, the overbased detergent is one or more magnesium-containing detergents, preferably the overbased detergent is a magnesium sulfonate detergent. If the magnesium-containing detergent are included, the lubricating compositions herein may include only a low level of such detergents, such as no more than 1 weight percent based on the total minerals of the lubricating compositions. Overbased magnesium-containing detergents may have a TBN of about 225 mg KOH/g or more, about 250 mg KOH/g or more, about 300 mg KOH/g or more or, in other approaches, about 300 mg KOH/g to about 450 mg KOH/g.

In certain embodiments, the total of the one or more overbased calcium-containing detergents may provide from about 1500 ppm to about 3000 ppm calcium to the finished fluid. As a further example, and as discussed above, the one or more overbased calcium-containing detergents may be present in an amount to provide from about 1800 ppm to about 3000 ppm calcium, or from about 2000 ppm to about 2800 ppm calcium, or from about 2000 ppm to 2600 ppm calcium, or from about 2200 ppm to 2400 ppm calcium to the finished fluid in a fluid that is free of or devoid of magnesium as noted above.

In each of the foregoing embodiments, the lubricating oil composition of the disclosure may include an optional low-based/neutral detergent which has a TBN of up to 170 mg KOH/g, or up to 150 mg KOH/g. The low-based/neutral detergent may include a calcium-containing detergent so long as the total calcium amounts meet the limits noted above. The low-based neutral calcium-containing detergent may be selected from a calcium sulfonate detergent, a calcium phenate detergent and a calcium salicylate detergent. In some embodiments, the low-based/neutral detergent is a calcium-containing detergent or a mixture of calcium-containing detergents. In some embodiments, the low-based/neutral detergent is a calcium sulfonate detergent or a calcium phenate detergent.

In some embodiments, the lubricating oil composition optionally does not have any overbased calcium salicylate detergents. In yet other embodiments, the lubricating oil may optionally exclude any magnesium-containing detergents or be free of magnesium. In any of the embodiments of the disclosure, the amount of sodium in the lubricating composition may be limited to not more than 150 ppm of sodium, based on a total weight of the lubricating oil composition or not more than 50 ppm of sodium, based on a total weight of the lubricating oil composition.

Base Oil

The base oil used in the lubricating oil compositions herein may be selected from any of the base oils in Groups I-V as specified in the American Petroleum Institute (API) Base Oil Interchangeability Guidelines. The five base oil groups are as follows:

TABLE 1

| Base oil | Sulfur | | Saturates | Viscosity |
|---|---|---|---|---|
| Category | (%) | | (%) | Index |
| Group I | >0.03 | and/or | <90 | 80 to 120 |
| Group II | ≤0.03 | and | ≥90 | 80 to 120 |
| Group III | ≤0.03 | and | ≥90 | ≥120 |
| Group IV | All polyalphaolefins | | | |
| | (PAOs) | | | |
| Group V | All others not | | | |
| | included in Groups | | | |
| | I, II, III, or IV | | | |

Groups I, II, and III are mineral oil process stocks. Group IV base oils contain true synthetic molecular species, which are produced by polymerization of olefinically unsaturated hydrocarbons. Many Group V base oils are also true synthetic products and may include diesters, polyol esters, polyalkylene glycols, alkylated aromatics, polyphosphate esters, polyvinyl ethers, and/or polyphenyl ethers, and the like, but may also be naturally occurring oils, such as vegetable oils. It should be noted that although Group III base oils are derived from mineral oil, the rigorous processing that these fluids undergo causes their physical properties to be very similar to some true synthetics, such as PAOs. Therefore, oils derived from Group III base oils may be referred to as synthetic fluids in the industry.

The base oil used in the disclosed lubricating oil composition may be a mineral oil, animal oil, vegetable oil, synthetic oil, or mixtures thereof. Suitable oils may be derived from hydrocracking, hydrogenation, hydrofinishing, unrefined, refined, and re-refined oils, and mixtures thereof.

Unrefined oils are those derived from a natural, mineral, or synthetic source without or with little further purification treatment. Refined oils are similar to the unrefined oils except that they have been treated in one or more purification steps, which may result in the improvement of one or more properties. Examples of suitable purification techniques are solvent extraction, secondary distillation, acid or base extraction, filtration, percolation, and the like. Oils refined to the quality of an edible may or may not be useful. Edible oils may also be called white oils. In some embodiments, lubricating oil compositions are free of edible or white oils.

Re-refined oils are also known as reclaimed or reprocessed oils. These oils are obtained similarly to refined oils using the same or similar processes. Often these oils are additionally processed by techniques directed to removal of spent additives and oil breakdown products.

Mineral oils may include oils obtained by drilling or from plants and animals or any mixtures thereof. For example such oils may include, but are not limited to, castor oil, lard oil, olive oil, peanut oil, corn oil, soybean oil, and linseed oil, as well as mineral lubricating oils, such as liquid petroleum oils and solvent-treated or acid-treated mineral lubricating oils of the paraffinic, naphthenic or mixed paraffinic-naphthenic types. Such oils may be partially or fully hydrogenated, if desired. Oils derived from coal or shale may also be useful.

Useful synthetic lubricating oils may include hydrocarbon oils such as polymerized, oligomerized, or interpolymerized olefins (e.g., polybutylenes, polypropylenes, propylene-isobutylene copolymers); poly(l-hexenes), poly(l-octenes), trimers or oligomers of 1-decene, e.g., poly(l-decenes), such materials being often referred to as α-olefins, and mixtures thereof; alkyl-benzenes (e.g. dodecylbenzenes, tetradecylbenzenes, dinonylbenzenes, di-(2-ethylhexyl)-benzenes); polyphenyls (e.g., biphenyls, terphenyls, alkylated polyphenyls); diphenyl alkanes, alkylated diphenyl alkanes, alkylated diphenyl ethers and alkylated diphenyl sulfides and the derivatives, analogs and homologs thereof or mixtures thereof. Polyalphaolefins are typically hydrogenated materials.

Other synthetic lubricating oils include polyol esters, diesters, liquid esters of phosphorus-containing acids (e.g., tricresyl phosphate, trioctyl phosphate, and the diethyl ester of decane phosphonic acid), or polymeric tetrahydrofurans. Synthetic oils may be produced by Fischer-Tropsch reactions and typically may be hydroisomerized Fischer-Tropsch hydrocarbons or waxes. In one embodiment oils may be prepared by a Fischer-Tropsch gas-to-liquid synthetic procedure as well as other gas-to-liquid oils.

The greater than 50 weight percent, of base oil included in a lubricating composition may be selected from the group consisting of Group I, Group II, a Group III, a Group IV, a Group V, and a combination of two or more of the foregoing, and wherein the greater than 50 wt % of base oil is other than base oils that arise from provision of additive components or viscosity index improvers in the composition. In another embodiment, the greater than 50 wt % of base oil included in a lubricating composition may be selected from the group consisting of Group II, a Group III, a Group IV, a Group V, and a combination of two or more of the foregoing. Also, the base oil may be selected from a Group II-Group V base oil or a mixture of any two or more thereof. The greater than 50 weight percent, of base oil, based on the total weight of the lubricating oil composition, may be other than diluent oils that arise from provision of additive components or viscosity index improvers to the composition.

The amount of the oil of lubricating viscosity present may be the balance remaining after subtracting from 100 weight percent, the sum of the amount of the performance additives inclusive of viscosity index improver(s) and/or pour point depressant(s) and/or other top treat additives. For example, the oil of lubricating viscosity that may be present in a finished fluid may be a major amount, such as greater than about 50 weight percent, greater than about 60 weight percent, greater than about 70 weight percent, greater than about 80 weight percent, greater than about 85 weight percent, or greater than about 90 weight percent.

The lubricating oil composition may comprise not more than 10 weight percent of a Group IV base oil, a Group V base oil, or a combination thereof. In each of the foregoing embodiments, the lubricating oil composition may comprise less than 5 weight percent of a Group V base oil. The lubricating oil composition of some embodiments does not contain any Group IV base oils and/or does not contain any Group V base oils.

Any of the embodiments of the lubricating oil compositions herein may also include one or more optional components selected from the various additives set forth below.

Antioxidants

The lubricating oil compositions herein also may optionally contain one or more antioxidants. Antioxidant compounds are known and include for example, phenates, phenate sulfides, sulfurized olefins, phosphosulfurized terpenes, sulfurized esters, aromatic amines, alkylated diphenylamines (e.g., nonyl diphenylamine, di-nonyl diphenylamine, octyl diphenylamine, di-octyl diphenylamine), phenyl-alpha-naphthylamines, alkylated phenyl-alpha-naphthylamines, hindered non-aromatic amines, phenols, hindered phenols, oil-soluble molybdenum compounds, macromolecular antioxidants, or mixtures thereof. Antioxidant compounds may be used alone or in combination.

The hindered phenol antioxidant may contain a secondary butyl and/or a tertiary butyl group as a sterically hindering group. The phenol group may be further substituted with a hydrocarbyl group and/or a bridging group linking to a second aromatic group. Examples of suitable hindered phenol antioxidants include 2,6-di-tert-butylphenol, 4-methyl-2,6-di-tert-butylphenol, 4-ethyl-2,6-di-tert-butylphenol, 4-propyl-2,6-di-tert-butylphenol or 4-butyl-2,6-di-tert-butylphenol, or 4-dodecyl-2,6-di-tert-butylphenol. In one embodiment the hindered phenol antioxidant may be an ester and may include, e.g., IRGANOX™ L-135 available from BASF or an addition product derived from 2,6-di-tert-butylphenol and an alkyl acrylate, wherein the alkyl group may contain about 1 to about 18, or about 2 to about 12, or about 2 to about 8, or about 2 to about 6, or about 4 carbon atoms. Another commercially available hindered phenol antioxidant may be an ester and may include ETHANOX™ 4716 available from Albemarle Corporation.

Useful antioxidants may include diarylamines and high molecular weight phenols. In an embodiment, the lubricating oil composition may contain a mixture of a diarylamine and a high molecular weight phenol, such that each antioxidant may be present in an amount sufficient to provide up to about 5%, by weight, based upon the final weight of the lubricating oil composition. In an embodiment, the antioxidant may be a mixture of about 0.3 to about 1.5% diarylamine and about 0.4 to about 2.5% high molecular weight phenol, by weight, based upon the final weight of the lubricating oil composition.

Examples of suitable olefins that may be sulfurized to form a sulfurized olefin include propylene, butylene, isobutylene, polyisobutylene, pentene, hexene, heptene, octene, nonene, decene, undecene, dodecene, tridecene, tetradecene, pentadecene, hexadecene, heptadecene, octadecene, nonadecene, eicosene or mixtures thereof. In one embodiment, hexadecene, heptadecene, octadecene, nonadecene, eicosene or mixtures thereof and their dimers, trimers and tetramers are especially useful olefins. Alternatively, the olefin may be a Diels-Alder adduct of a diene such as 1,3-butadiene and an unsaturated ester, such as, butylacrylate.

Another class of sulfurized olefin includes sulfurized fatty acids and their esters. The fatty acids are often obtained from vegetable oil or animal oil and typically contain about 4 to about 22 carbon atoms. Examples of suitable fatty acids and their esters include triglycerides, oleic acid, linoleic acid, palmitoleic acid or mixtures thereof. Often, the fatty acids are obtained from lard oil, tall oil, peanut oil, soybean oil, cottonseed oil, sunflower seed oil or mixtures thereof. Fatty acids and/or ester may be mixed with olefins, such as α-olefins.

The one or more antioxidant(s) may be present in ranges about 0 wt % to about 20 wt %, or about 0.1 wt % to about 10 wt %, or about 1 wt % to about 5 wt %, of the lubricating oil composition.

Antiwear Agents

The lubricating oil compositions herein also may optionally contain one or more antiwear agents. Examples of suitable antiwear agents include, but are not limited to, a metal thiophosphate; a metal dialkyldithiophosphate; a phosphoric acid ester or salt thereof; a phosphate ester(s); a phosphite; a phosphorus-containing carboxylic ester, ether, or amide; a sulfurized olefin; thiocarbamate-containing compounds including, thiocarbamate esters, alkylene-coupled thiocarbamates, and bis(S-alkyldithiocarbamyl)disulfides; and mixtures thereof. A suitable antiwear agent may be a molybdenum dithiocarbamate. The phosphorus containing antiwear agents are more fully described in European Patent 612 839. The metal in the dialkyl dithio phosphate salts may be an alkali metal, alkaline earth metal, aluminum, lead, tin, molybdenum, manganese, nickel, copper, titanium, or zinc. A useful antiwear agent may be zinc dialkyldithiophosphate.

Further examples of suitable antiwear agents include titanium compounds, tartrates, tartrimides, oil soluble amine salts of phosphorus compounds, sulfurized olefins, phosphites (such as dibutyl phosphite), phosphonates, thiocarbamate-containing compounds, such as thiocarbamate esters, thiocarbamate amides, thiocarbamic ethers, alkylene-coupled thiocarbamates, and bis(S-alkyldithiocarbamyl) disulfides. The tartrate or tartrimide may contain alkyl-ester groups, where the sum of carbon atoms on the alkyl groups may be at least 8. The antiwear agent may in one embodiment include a citrate.

The antiwear agent may be present in ranges including about 0 wt % to about 15 wt %, or about 0.01 wt % to about 10 wt %, or about 0.05 wt % to about 5 wt %, or about 0.1 wt % to about 3 wt % of the lubricating oil composition.

An antiwear compound may be a zinc dihydrocarbyl dithiophosphate (ZDDP) having a P:Zn ratio of from about 1:0.8 to about 1:1.7. The dihydrocarbyl groups of the ZDDP may be formed from a mixture of C3 and C6 alcohols.

Boron-Containing Compounds

The lubricating oil compositions herein may optionally contain one or more boron-containing compounds. The amount of boron in the lubricating oil composition is less than 200 ppm by weight, based on the total weight of the lubricating oil composition, or less than 100 ppm by weight, based on the total weight of the lubricating oil composition, or less than 50 ppm by weight, based on the total weight of the lubricating oil composition.

Examples of boron-containing compounds include borate esters, borated fatty amines, borated epoxides, borated detergents, and borated dispersants, such as borated succinimide dispersants, as disclosed in U.S. Pat. No. 5,883,057.

The one or more boron-containing compounds, if present, can be used in an amount sufficient to provide less than 200 ppm by weight boron to the lubricating oil composition or less than 100 ppm by weight boron to the lubricating oil composition or less than 50 ppm by weight boron to the lubricating oil composition.

Dispersants

The lubricating oil composition may optionally further comprise one or more dispersants or mixtures thereof. Dispersants are often known as ashless-type dispersants because, prior to mixing in a lubricating oil composition, they do not contain ash-forming metals and they do not normally contribute any ash when added to a lubricant. Ashless type dispersants are characterized by a polar group attached to a relatively high molecular weight hydrocarbon chain. Typical ashless dispersants include N-substituted long chain alkenyl succinimides. Examples of N-substituted long chain alkenyl succinimides include polyisobutylene succinimide with number average molecular weight of the polyisobutylene substituent in the range about 350 to about 50,000, or to about 5,000, or to about 3,000. Succinimide dispersants and their preparation are disclosed, for instance in U.S. Pat. No. 7,897,696 or U.S. Pat. No. 4,234,435. The polyolefin may be prepared from polymerizable monomers containing about 2 to about 16, or about 2 to about 8, or about 2 to about 6 carbon atoms. Succinimide dispersants are typically the imide formed from a polyamine, typically a poly(ethyleneamine).

In an embodiment the present disclosure further comprises at least one polyisobutylene succinimide dispersant derived from polyisobutylene with number average molecular weight in the range about 350 to about 50,000, or to about 5000, or to about 3000. The polyisobutylene succinimide may be used alone or in combination with other dispersants.

In some embodiments, polyisobutylene, when included, may have greater than 50 mol %, greater than 60 mol %, greater than 70 mol %, greater than 80 mol %, or greater than 90 mol % content of terminal double bonds. Such PIB is also referred to as highly reactive PIB (“HR-PIB”). HR-PIB having a number average molecular weight ranging from about 800 to about 5000 is suitable for use in embodiments of the present disclosure. Conventional PIB typically has less than 50 mol %, less than 40 mol %, less than 30 mol %, less than 20 mol %, or less than 10 mol % content of terminal double bonds.

An HR-PIB having a number average molecular weight ranging from about 900 to about 3000 may be suitable. Such HR-PIB is commercially available, or can be synthesized by the polymerization of isobutene in the presence of a non-chlorinated catalyst such as boron trifluoride, as described in U.S. Pat. No. 4,152,499 to Boerzel, et al. and U.S. Pat. No. 5,739,355 to Gateau, et al. When used in the aforementioned thermal ene reaction, HR-PIB may lead to higher conversion rates in the reaction, as well as lower amounts of sediment formation, due to increased reactivity. A suitable method is described in U.S. Pat. No. 7,897,696.

In one embodiment the present disclosure further comprises at least one dispersant derived from polyisobutylene succinic anhydride (“PIMA”). The PIMA may have an average of between about 1.0 and about 2.0 succinic acid moieties per polymer.

The % actives of the alkenyl or alkyl succinic anhydride can be determined using a chromatographic technique. This method is described in column 5 and 6 in U.S. Pat. No. 5,334,321.

The percent conversion of the polyolefin is calculated from the % actives using the equation in column 5 and 6 in U.S. Pat. No. 5,334,321.

Unless stated otherwise, all percentages are in weight percent and all molecular weights are number average molecular weights.

In one embodiment, the dispersant may be derived from a polyalphaolefin (PAO) succinic anhydride.

In one embodiment, the dispersant may be derived from olefin maleic anhydride copolymer. As an example, the dispersant may be described as a poly-PIBSA.

In an embodiment, the dispersant may be derived from an anhydride which is grafted to an ethylene-propylene copolymer.

One class of suitable dispersants may be Mannich bases. Mannich bases are materials that are formed by the condensation of a higher molecular weight, alkyl substituted phenol, a polyalkylene polyamine, and an aldehyde such as formaldehyde. Mannich bases are described in more detail in U.S. Pat. No. 3,634,515.

A suitable class of dispersants may be high molecular weight esters or half ester amides.

A suitable dispersant may also be post-treated by conventional methods by a reaction with any of a variety of agents. Among these are boron, urea, thiourea, dimercaptothiadiazoles, carbon disulfide, aldehydes, ketones, carboxylic acids, hydrocarbon-substituted succinic anhydrides, maleic anhydride, nitriles, epoxides, carbonates, cyclic carbonates, hindered phenolic esters, and phosphorus compounds. U.S. Pat. Nos. 7,645,726; 7,214,649; and 8,048,831 are incorporated herein by reference in their entireties.

In addition to the carbonate and boric acids post-treatments both the compounds may be post-treated, or further post-treatment, with a variety of post-treatments designed to improve or impart different properties. Such post-treatments include those summarized in columns 27-29 of U.S. Pat. No. 5,241,003, hereby incorporated by reference. Such treatments include, treatment with: Inorganic phosphorous acids or anhydrates (e.g., U.S. Pat. Nos. 3,403,102 and 4,648,980); Organic phosphorous compounds (e.g., U.S. Pat. No. 3,502,677); Phosphorous pentasulfides;

Boron compounds as already noted above (e.g., U.S. Pat. Nos. 3,178,663 and 4,652,387); Carboxylic acid, polycarboxylic acids, anhydrides and/or acid halides (e.g., U.S. Pat. Nos. 3,708,522 and 4,948,386); Epoxides, polyepoxides or thioexpoxides (e.g., U.S. Pat. Nos. 3,859,318 and 5,026,495); Aldehyde or ketone (e.g., U.S. Pat. No. 3,458,530); Carbon disulfide (e.g., U.S. Pat. No. 3,256,185); Glycidol (e.g., U.S. Pat. No. 4,617,137); Urea, thourea or guanidine (e.g., U.S. Pat. Nos. 3,312,619; 3,865,813; and British Patent GB 1,065,595); Organic sulfonic acid (e.g., U.S. Pat. No. 3,189,544 and British Patent GB 2,140,811); Alkenyl cyanide (e.g., U.S. Pat. Nos. 3,278,550 and 3,366,569); Diketene (e.g., U.S. Pat. No. 3,546,243); a diisocyanate (e.g., U.S. Pat. No. 3,573,205); Alkane sultone (e.g., U.S. Pat. No. 3,749,695); 1,3-Dicarbonyl Compound (e.g., U.S. Pat. No. 4,579,675); Sulfate of alkoxylated alcohol or phenol (e.g., U.S. Pat. No. 3,954,639); Cyclic lactone (e.g., U.S. Pat. Nos. 4,617,138; 4,645,515; 4,668,246; 4,963,275; and 4,971,711); Cyclic carbonate or thiocarbonate linear monocarbonate or polycarbonate, or chloroformate (e.g., U.S. Pat. Nos. 4,612,132; 4,647,390; 4,648,886; 4,670,170); Nitrogen-containing carboxylic acid (e.g., U.S. Pat. No. 4,971,598 and British Patent GB 2,140,811); Hydroxy-protected chlorodicarbonyloxy compound (e.g., U.S. Pat. No. 4,614,522); Lactam, thiolactam, thiolactone or ditholactone (e.g., U.S. Pat. Nos. 4,614,603 and 4,666,460); Cyclic carbonate or thiocarbonate, linear monocarbonate or polycarbonate, or chloroformate (e.g., U.S. Pat. Nos. 4,612,132; 4,647,390; 4,646,886; and 4,670,170); Nitrogen-containing carboxylic acid (e.g., U.S. Pat. No. 4,971,598 and British Patent GB 2,440,811); Hydroxy-protected chlorodicarbonyloxy compound (e.g., U.S. Pat. No. 4,614,522); Lactam, thiolactam, thiolactone or dithiolactone (e.g., U.S. Pat. Nos. 4,614,603, and 4,666,460); Cyclic carbamate, cyclic thiocarbamate or cyclic dithiocarbamate (e.g., U.S. Pat. Nos. 4,663,062 and 4,666,459); Hydroxyaliphatic carboxylic acid (e.g., U.S. Pat. Nos. 4,482,464; 4,521,318; 4,713,189); Oxidizing agent (e.g., U.S. Pat. No. 4,379,064); Combination of phosphorus pentasulfide and a polyalkylene polyamine (e.g., U.S. Pat. No. 3,185,647); Combination of carboxylic acid or an aldehyde or ketone and sulfur or sulfur chloride (e.g., U.S. Pat. Nos. 3,390,086; 3,470,098); Combination of a hydrazine and carbon disulfide (e.g. U.S. Pat. No. 3,519,564); Combination of an aldehyde and a phenol (e.g., U.S. Pat. Nos. 3,649,229; 5,030,249; 5,039,307); Combination of an aldehyde and an O-diester of dithiophosphoric acid (e.g., U.S. Pat. No. 3,865,740); Combination of a hydroxyaliphatic carboxylic acid and a boric acid (e.g., U.S. Pat. No. 4,554,086); Combination of a hydroxyaliphatic carboxylic acid, then formaldehyde and a phenol (e.g., U.S. Pat. No. 4,636,322); Combination of a hydroxyaliphatic carboxylic acid and then an aliphatic dicarboxylic acid (e.g., U.S. Pat. No. 4,663,064); Combination of formaldehyde and a phenol and then glycolic acid (e.g., U.S. Pat. No. 4,699,724); Combination of a hydroxyaliphatic carboxylic acid or oxalic acid and then a diisocyanate (e.g. U.S. Pat. No. 4,713,191); Combination of inorganic acid or anhydride of phosphorus or a partial or total sulfur analog thereof and a boron compound (e.g., U.S. Pat. No. 4,857,214); Combination of an organic diacid then an unsaturated fatty acid and then a nitrosoaromatic amine optionally followed by a boron compound and then a glycolating agent (e.g., U.S. Pat. No. 4,973,412); Combination of an aldehyde and a triazole (e.g., U.S. Pat. No. 4,963,278); Combination of an aldehyde and a triazole then a boron compound (e.g., U.S. Pat. No. 4,981,492); Combination of cyclic lactone and a boron compound (e.g., U.S. Pat. Nos. 4,963,275 and 4,971,711). The above mentioned patents are herein incorporated in their entireties.

The TBN of a suitable dispersant may be from about 10 to about 65 on an oil-free basis, which is comparable to about 5 to about 30 TBN if measured on a dispersant sample containing about 50% diluent oil.

The dispersant, if present, can be used in an amount sufficient to provide up to about 20 wt %, based upon the final weight of the lubricating oil composition. Another amount of the dispersant that can be used may be about 0.1 wt % to about 15 wt %, or about 0.1 wt % to about 10 wt %, or about 3 wt % to about 10 wt %, or about 1 wt % to about 6 wt %, or about 7 wt % to about 12 wt %, based upon the final weight of the lubricating oil composition. In some embodiments, the lubricating oil composition utilizes a mixed dispersant system. A single type or a mixture of two or more types of dispersants in any desired ratio may be used.

Friction Modifiers

The lubricating oil compositions herein also may optionally contain one or more friction modifiers. Suitable friction modifiers may comprise metal containing and metal-free friction modifiers and may include, but are not limited to, imidazolines, amides, amines, succinimides, alkoxylated amines, alkoxylated ether amines, amine oxides, amidoamines, nitriles, betaines, quaternary amines, imines, amine salts, amino guanadine, alkanolamides, phosphonates, metal-containing compounds, glycerol esters, sulfurized fatty compounds and olefins, sunflower oil other naturally occurring plant or animal oils, dicarboxylic acid esters, esters or partial esters of a polyol and one or more aliphatic or aromatic carboxylic acids, and the like.

Suitable friction modifiers may contain hydrocarbyl groups that are selected from straight chain, branched chain, or aromatic hydrocarbyl groups or mixtures thereof, and may be saturated or unsaturated. The hydrocarbyl groups may be composed of carbon and hydrogen or hetero atoms such as sulfur or oxygen. The hydrocarbyl groups may range from about 12 to about 25 carbon atoms. In some embodiments the friction modifier may be a long chain fatty acid ester. In another embodiment the long chain fatty acid ester may be a mono-ester, or a di-ester, or a (tri)glyceride. The friction modifier may be a long chain fatty amide, a long chain fatty ester, a long chain fatty epoxide derivatives, or a long chain imidazoline.

Other suitable friction modifiers may include organic, ashless (metal-free), nitrogen-free organic friction modifiers. Such friction modifiers may include esters formed by reacting carboxylic acids and anhydrides with alkanols and generally include a polar terminal group (e.g. carboxyl or hydroxyl) covalently bonded to an oleophilic hydrocarbon chain. An example of an organic ashless nitrogen-free friction modifier is known generally as glycerol monooleate (GMO) which may contain mono-, di-, and tri-esters of oleic acid. Other suitable friction modifiers are described in U.S. Pat. No. 6,723,685, herein incorporated by reference in its entirety.

Aminic friction modifiers may include amines or polyamines. Such compounds can have hydrocarbyl groups that are linear, either saturated or unsaturated, or a mixture thereof and may contain from about 12 to about 25 carbon atoms. Further examples of suitable friction modifiers include alkoxylated amines and alkoxylated ether amines. Such compounds may have hydrocarbyl groups that are linear, either saturated, unsaturated, or a mixture thereof. They may contain from about 12 to about 25 carbon atoms. Examples include ethoxylated amines and ethoxylated ether amines.

The amines and amides may be used as such or in the form of an adduct or reaction product with a boron compound such as a boric oxide, boron halide, metaborate, boric acid or a mono-, di- or tri-alkyl borate. Other suitable friction modifiers are described in U.S. Pat. No. 6,300,291, herein incorporated by reference in its entirety.

A friction modifier may optionally be present in ranges such as about 0 wt % to about 10 wt %, or about 0.01 wt % to about 8 wt %, or about 0.1 wt % to about 4 wt %.

Molybdenum-Containing Component

The lubricating oil compositions herein also may optionally contain one or more molybdenum-containing compounds. An oil-soluble molybdenum compound may have the functional performance of an antiwear agent, an antioxidant, a friction modifier, or mixtures thereof. An oil-soluble molybdenum compound may include molybdenum dithiocarbamates, molybdenum dialkyldithiophosphates, molybdenum dithiophosphinates, amine salts of molybdenum compounds, molybdenum xanthates, molybdenum thioxanthates, molybdenum sulfides, molybdenum carboxylates, molybdenum alkoxides, a trinuclear organo-molybdenum compound, and/or mixtures thereof. The molybdenum sulfides include molybdenum disulfide. The molybdenum disulfide may be in the form of a stable dispersion. In one embodiment the oil-soluble molybdenum compound may be selected from the group consisting of molybdenum dithiocarbamates, molybdenum dialkyldithiophosphates, amine salts of molybdenum compounds, and mixtures thereof. In one embodiment the oil-soluble molybdenum compound may be a molybdenum dithiocarbamate.

Suitable examples of molybdenum compounds which may be used include commercial materials sold under the trade names such as Molyvan 822™, Molyvan™ A, Molyvan 2000™ and Molyvan 855™ from R. T. Vanderbilt Co., Ltd., and Sakura-Lube™ S-165, S-200, S-300, 5-310G, S-525, S-600, S-700, and S-710 available from Adeka Corporation, and mixtures thereof. Suitable molybdenum components are described in U.S. Pat. No. 5,650,381; US RE 37,363 E1; US RE 38,929 E1; and US RE 40,595 E1, incorporated herein by reference in their entireties.

Additionally, the molybdenum compound may be an acidic molybdenum compound. Included are molybdic acid, ammonium molybdate, sodium molybdate, potassium molybdate, and other alkaline metal molybdates and other molybdenum salts, e.g., hydrogen sodium molybdate, MoOCl₄, MoO₂Br₂, Mo₂O₃Cl₆, molybdenum trioxide or similar acidic molybdenum compounds. Alternatively, the compositions can be provided with molybdenum by molybdenum/sulfur complexes of basic nitrogen compounds as described, for example, in U.S. Pat. Nos. 4,263,152; 4,285,822; 4,283,295; 4,272,387; 4,265,773; 4,261,843; 4,259,195 and 4,259,194; and US Patent Publication No. 2002/0038525, incorporated herein by reference in their entireties.

Another class of suitable organo-molybdenum compounds are trinuclear molybdenum compounds, such as those of the formula Mo₃SₖLₙQ_{z} and mixtures thereof, wherein S represents sulfur, L represents independently selected ligands having organo groups with a sufficient number of carbon atoms to render the compound soluble or dispersible in the oil, n is from 1 to 4, k varies from 4 through 7, Q is selected from the group of neutral electron donating compounds such as water, amines, alcohols, phosphines, and ethers, and z ranges from 0 to 5 and includes non-stoichiometric values. At least 21 total carbon atoms may be present among all the ligands' organo groups, such as at least 25, at least 30, or at least 35 carbon atoms. Additional suitable molybdenum compounds are described in U.S. Pat. No. 6,723,685, herein incorporated by reference in its entirety.

The oil-soluble molybdenum compound may be present in an amount sufficient to provide about 0.5 ppm to about 2000 ppm, about 1 ppm to about 700 ppm, about 1 ppm to about 550 ppm, about 5 ppm to about 450 ppm, or about 90 ppm to about 350 ppm of molybdenum.

Titanium-Containing Compounds

Another class of additives includes oil-soluble titanium compounds. The oil-soluble titanium compounds may function as antiwear agents, friction modifiers, antioxidants, deposit control additives, or more than one of these functions. In an embodiment the oil soluble titanium compound may be a titanium (IV) alkoxide. The titanium alkoxide may be formed from a monohydric alcohol, a polyol, or mixtures thereof. The monohydric alkoxides may have 2 to 16, or 3 to 10 carbon atoms. In an embodiment, the titanium alkoxide may be titanium (IV) isopropoxide. In an embodiment, the titanium alkoxide may be titanium (IV) 2-ethylhexoxide. In an embodiment, the titanium compound may be the alkoxide of a 1,2-diol or polyol. In an embodiment, the 1,2-diol comprises a fatty acid mono-ester of glycerol, such as oleic acid. In an embodiment, the oil soluble titanium compound may be a titanium carboxylate. In an embodiment the titanium (IV) carboxylate may be titanium neodecanoate.

In an embodiment the oil soluble titanium compound may be present in the lubricating oil composition in an amount to provide from zero to about 1500 ppm titanium by weight or about 10 ppm to 500 ppm titanium by weight or about 25 ppm to about 150 ppm.

Transition Metal-Containing Compounds

In another embodiment, the oil-soluble compound may be a transition metal containing compound or a metalloid. The transition metals may include, but are not limited to, titanium, vanadium, copper, zinc, zirconium, molybdenum, tantalum, tungsten, and the like. Suitable metalloids include, but are not limited to, boron, silicon, antimony, tellurium, and the like.

In one embodiment, the oil-soluble compound that may be used in a weight ratio of Ca/M ranging from about 0.8:1 to about 70:1 is a titanium containing compound, wherein M is the total metal in the lubricating oil composition as described above. The titanium-containing compounds may function as antiwear agents, friction modifiers, antioxidants, deposit control additives, or more than one of these functions. Among the titanium containing compounds that may be used in, or which may be used for preparation of the oils-soluble materials of, the disclosed technology are various Ti (IV) compounds such as titanium (IV) oxide; titanium (IV) sulfide; titanium (IV) nitrate; titanium (IV) alkoxides such as titanium methoxide, titanium ethoxide, titanium propoxide, titanium isopropoxide, titanium butoxide, titanium 2-ethylhexoxide; and other titanium compounds or complexes including but not limited to titanium phenates; titanium carboxylates such as titanium (IV) 2-ethyl-1-3-hexanedioate or titanium citrate or titanium oleate; and titanium (IV) (triethanolaminato)isopropoxide. Other forms of titanium encompassed within the disclosed technology include titanium phosphates such as titanium dithiophosphates (e.g., dialkyldithiophosphates) and titanium sulfonates (e.g., alkylbenzenesulfonates), or, generally, the reaction product of titanium compounds with various acid materials to form salts, such as oil-soluble salts. Titanium compounds can thus be derived from, among others, organic acids, alcohols, and glycols. Ti compounds may also exist in dimeric or oligomeric form, containing Ti—O—Ti structures. Such titanium materials are commercially available or can be readily prepared by appropriate synthesis techniques which will be apparent to the person skilled in the art. They may exist at room temperature as a solid or a liquid, depending on the particular compound. They may also be provided in a solution form in an appropriate inert solvent.

In one embodiment, the titanium can be supplied as a Ti-modified dispersant, such as a succinimide dispersant. Such materials may be prepared by forming a titanium mixed anhydride between a titanium alkoxide and a hydrocarbyl-substituted succinic anhydride, such as an alkenyl- (or alkyl) succinic anhydride. The resulting titanate-succinate intermediate may be used directly or it may be reacted with any of a number of materials, such as (a) a polyamine-based succinimide/amide dispersant having free, condensable —NH functionality; (b) the components of a polyamine-based succinimide/amide dispersant, i.e., an alkenyl- (or alkyl-) succinic anhydride and a polyamine, (c) a hydroxy-containing polyester dispersant prepared by the reaction of a substituted succinic anhydride with a polyol, aminoalcohol, polyamine, or mixtures thereof. Alternatively, the titanate-succinate intermediate may be reacted with other agents such as alcohols, aminoalcohols, ether alcohols, polyether alcohols or polyols, or fatty acids, and the product thereof either used directly to impart Ti to a lubricant, or else further reacted with the succinic dispersants as described above. As an example, 1 part (by mole) of tetraisopropyl titanate may be reacted with about 2 parts (by mole) of a polyisobutene-substituted succinic anhydride at 140-150° C. for 5 to 6 hours to provide a titanium modified dispersant or intermediate. The resulting material (30 g) may be further reacted with a succinimide dispersant from polyisobutene-substituted succinic anhydride and a polyethylenepolyamine mixture (127 grams+diluent oil) at 150° C. for 1.5 hours, to produce a titanium-modified succinimide dispersant.

Another titanium containing compound may be a reaction product of titanium alkoxide and C₆ to C₂₅ carboxylic acid. The reaction product may be represented by the following formula:

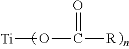

wherein n is an integer selected from 2, 3 and 4, and R is a hydrocarbyl group containing from about 5 to about 24 carbon atoms, or by the formula

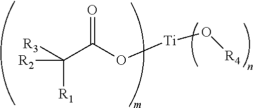

wherein m+n=4 and n ranges from 1 to 3, R₄ is an alkyl moiety with carbon atoms ranging from 1-8, R₁ is selected from a hydrocarbyl group containing from about 6 to 25 carbon atoms, and R₂ and R₃ are the same or different and are selected from a hydrocarbyl group containing from about 1 to 6 carbon atoms, or by the formula

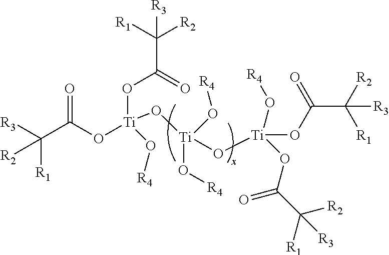

wherein x ranges from 0 to 3, R₁ is selected from a hydrocarbyl group containing from about 6 to 25 carbon atoms, R₂, and R₃ are the same or different and are selected from a hydrocarbyl group containing from about 1 to 6 carbon atoms, and R₄ is selected from a group consisting of either H, or C₆ to C₂₅ carboxylic acid moiety.

Suitable carboxylic acids may include, but are not limited to caproic acid, caprylic acid, lauric acid, myristic acid, palmitic acid, stearic acid, arachidic acid, oleic acid, erucic acid, linoleic acid, linolenic acid, cyclohexanecarboxylic acid, phenylacetic acid, benzoic acid, neodecanoic acid, and the like.

In an embodiment the oil soluble titanium compound may be present in the lubricating oil composition in an amount to provide from 0 to 3000 ppm titanium by weight or 25 to about 1500 ppm titanium by weight or about 35 ppm to 500 ppm titanium by weight or about 50 ppm to about 300 ppm.

Viscosity Index Improvers

The lubricating oil compositions herein also may optionally contain one or more viscosity index improvers. Suitable viscosity index improvers may include polyolefins, olefin copolymers, ethylene/propylene copolymers, polyisobutenes, hydrogenated styrene-isoprene polymers, styrene/maleic ester copolymers, hydrogenated styrene/butadiene copolymers, hydrogenated isoprene polymers, alpha-olefin maleic anhydride copolymers, polymethacrylates, polyacrylates, polyalkyl styrenes, hydrogenated alkenyl aryl conjugated diene copolymers, or mixtures thereof. Viscosity index improvers may include star polymers and suitable examples are described in U.S. Pat. No. 8,999,905 B2.

The lubricating oil compositions herein also may optionally contain one or more dispersant viscosity index improvers in addition to a viscosity index improver or in lieu of a viscosity index improver. Suitable viscosity index improvers may include functionalized polyolefins, for example, ethylene-propylene copolymers that have been functionalized with the reaction product of an acylating agent (such as maleic anhydride) and an amine; polymethacrylates functionalized with an amine, or esterified maleic anhydride-styrene copolymers reacted with an amine.

The total amount of viscosity index improver and/or dispersant viscosity index improver may be about 0 wt % to about 20 wt %, about 0.1 wt % to about 15 wt %, about 0.1 wt % to about 12 wt %, or about 0.5 wt % to about 10 wt %, of the lubricating oil composition.

Other Optional Additives

Other additives may be selected to perform one or more functions required of a lubricating fluid. Further, one or more of the mentioned additives may be multi-functional and provide functions in addition to or other than the function prescribed herein.

A lubricating oil composition according to the present disclosure may optionally comprise other performance additives. The other performance additives may be in addition to specified additives of the present disclosure and/or may comprise one or more of metal deactivators, viscosity index improvers, ashless TBN boosters, friction modifiers, antiwear agents, corrosion inhibitors, rust inhibitors, dispersants, dispersant viscosity index improvers, extreme pressure agents, antioxidants, foam inhibitors, demulsifiers, emulsifiers, pour point depressants, seal swelling agents and mixtures thereof. Typically, fully-formulated lubricating oil will contain one or more of these performance additives.

Suitable metal deactivators may include derivatives of benzotriazoles (typically tolyltriazole), dimercaptothiadiazole derivatives, 1,2,4-triazoles, benzimidazoles, 2-alkyldithiobenzimidazoles, or 2-alkyldithiobenzothiazoles; foam inhibitors including copolymers of ethyl acrylate and 2-ethylhexylacrylate and optionally vinyl acetate; demulsifiers including trialkyl phosphates, polyethylene glycols, polyethylene oxides, polypropylene oxides and (ethylene oxide-propylene oxide) polymers; pour point depressants including esters of maleic anhydride-styrene, polymethacrylates, polyacrylates or polyacrylamides.

Suitable foam inhibitors include silicon-based compounds, such as siloxane.

Suitable pour point depressants may include a polymethylmethacrylates or mixtures thereof. Pour point depressants may be present in an amount sufficient to provide from about 0 wt % to about 1 wt %, about 0.01 wt % to about 0.5 wt %, or about 0.02 wt % to about 0.04 wt % based upon the final weight of the lubricating oil composition.

Suitable rust inhibitors may be a single compound or a mixture of compounds having the property of inhibiting corrosion of ferrous metal surfaces. Non-limiting examples of rust inhibitors useful herein include oil-soluble high molecular weight organic acids, such as 2-ethylhexanoic acid, lauric acid, myristic acid, palmitic acid, oleic acid, linoleic acid, linolenic acid, behenic acid, and cerotic acid, as well as oil-soluble polycarboxylic acids including dimer and trimer acids, such as those produced from tall oil fatty acids, oleic acid, and linoleic acid. Other suitable corrosion inhibitors include long-chain alpha, omega-dicarboxylic acids in the molecular weight range of about 600 to about 3000 and alkenylsuccinic acids in which the alkenyl group contains about 10 or more carbon atoms such as, tetrapropenylsuccinic acid, tetradecenylsuccinic acid, and hexadecenylsuccinic acid. Another useful type of acidic corrosion inhibitors are the half esters of alkenyl succinic acids having about 8 to about 24 carbon atoms in the alkenyl group with alcohols such as the polyglycols. The corresponding half amides of such alkenyl succinic acids are also useful. A useful rust inhibitor is a high molecular weight organic acid. In some embodiments, an engine oil is devoid of a rust inhibitor.

The rust inhibitor, if present, can be used in an amount sufficient to provide about 0 wt % to about 5 wt %, about 0.01 wt % to about 3 wt %, about 0.1 wt % to about 2 wt %, based upon the final weight of the lubricating oil composition.

In general terms, a suitable lubricant may include additive components in the ranges listed in the following table.

TABLE 2

| | Wt. % | Wt. % |
|---|---|---|
| Component | (Broad) | (Typical) |
| Dispersant(s) | 0.0-10% | 1.0-8.5% |
| Antioxidant(s) | 0.0-5.0 | 0.01-3.0 |
| Metal Detergent(s) | 0.1-15.0 | 0.2-8.0 |
| Ashless TBN booster(s) | 0.0-1.0 | 0.01-0.5 |
| Corrosion Inhibitor(s) | 0.0-5.0 | 0.0-2.0 |
| Metal dihydrocarbyl dithiophosphate(s) | 0.1-6.0 | 0.1-4.0 |
| Ash-free amine phosphate salt(s) | 0.0-3.0 | 0.0-1.5 |
| Antifoaming agent(s) | 0.0-5.0 | 0.001-0.15 |
| Antiwear agent(s) | 0.0-10.0 | 0.0-5.0 |
| Pour point depressant(s) | 0.0-5.0 | 0.01-1.5 |
| Viscosity index improver(s) | 0.0-20.00 | 0.25-10.0 |
| Dispersant viscosity index improver(s) | 0.0-10.0 | 0.0-5.0 |
| Friction modifier(s) | 0.01-5.0 | 0.05-2.0 |
| Base oil(s) | Balance | Balance |
| Total | 100 | 100 |

The percentages of each component above represent the weight percent of each component, based upon the weight of the final lubricating oil composition. The remainder of the lubricating oil composition consists of one or more base oils. Additives used in formulating the compositions described herein may be blended into the base oil individually or in various sub-combinations. However, it may be suitable to blend all of the components concurrently using an additive concentrate (i.e., additives plus a diluent, such as a hydrocarbon solvent). Additives used in formulating the compositions described herein may be blended into the base oil individually or in various sub-combinations. However, it may be suitable to blend all of the components concurrently using an additive concentrate (i.e., additives plus a diluent, such as a hydrocarbon solvent).

Fully formulated lubricants conventionally contain an additive package, referred to herein as a dispersant/inhibitor package or DI package, that will supply the characteristics that are required in the formulations. Suitable DI packages are described for example in U.S. Pat. Nos. 5,204,012 and 6,034,040 for example. Among the types of additives included in the additive package may be dispersants, seal swell agents, antioxidants, foam inhibitors, lubricity agents, rust inhibitors, corrosion inhibitors, demulsifiers, viscosity index improvers, and the like. Several of these components are well known to those skilled in the art and are generally used in conventional amounts with the additives and compositions described herein.

### EXAMPLES

The following examples are illustrative of exemplary embodiments of the disclosure. In these examples, as well as elsewhere in this application, all ratios, parts, and percentages are by weight unless otherwise indicated. It is intended that these examples are being presented for the purpose of illustration only and are not intended to limit the scope of the invention disclosed herein.

### Example 1

Two lubricant oil compositions were prepared for evaluation of particulate emissions when lubricating a gasoline engine. Table 3 below provides analytic results of the Inventive Lubricant A and the mixed calcium/magnesium Comparative Lubricant B for the methods herein.

TABLE 3

| | | | Inventive | Comparative |
|---|---|---|---|---|
| Property | Mineral | UNIT | Lubricant A | Lubricant B |
| KV40 | — | cst | 43.6 | 43.6 |
| Minerals | Mo | ppm | 84 | 85 |
| (ICP) | P | ppm | 762 | 766 |
| | Zn | ppm | 841 | 889 |
| | B | ppm | 239 | 250 |
| | Mg | ppm | 8 | 550 |
| | Ca | ppm | 2243 | 1418 |
| | Total Minerals | ppm | 4177 | 3958 |

For the lubricants, each included a Group III base oil and an additive package including a viscosity index improver, dispersants, an antifoam agent, an aminic antioxidant, ZDDP antiwear agents, a sulfurized olefin anti-oxidant, friction modifiers, a pour point depressant, and a detergent system. The Inventive Lubricant A included 1.8 weight percent of an overbased calcium sulfonate having a TBN of 300 providing the calcium and the Comparative Lubricant B included 1.1 weight percent of the overbased calcium sulfonate and also 0.63 weight percent of an overbased magnesium sulfonate having a TBN of about 405 providing the magnesium.

Inventive Lubricant A had a weight ratio of calcium-to-magnesium of about 280:1 and about 53 weight percent of the total minerals (where the total minerals include molybdenum, phosphorus, zinc, boron, magnesium, and calcium) was calcium and about 0.19 weight percent of the total minerals was magnesium. For Comparative Lubricant B, it had a weight ratio of calcium-to-magnesium of about 2.6:1 and about 35 weight percent of the total minerals was calcium and about 14 weight percent of the total minerals was magnesium.

### Example 2

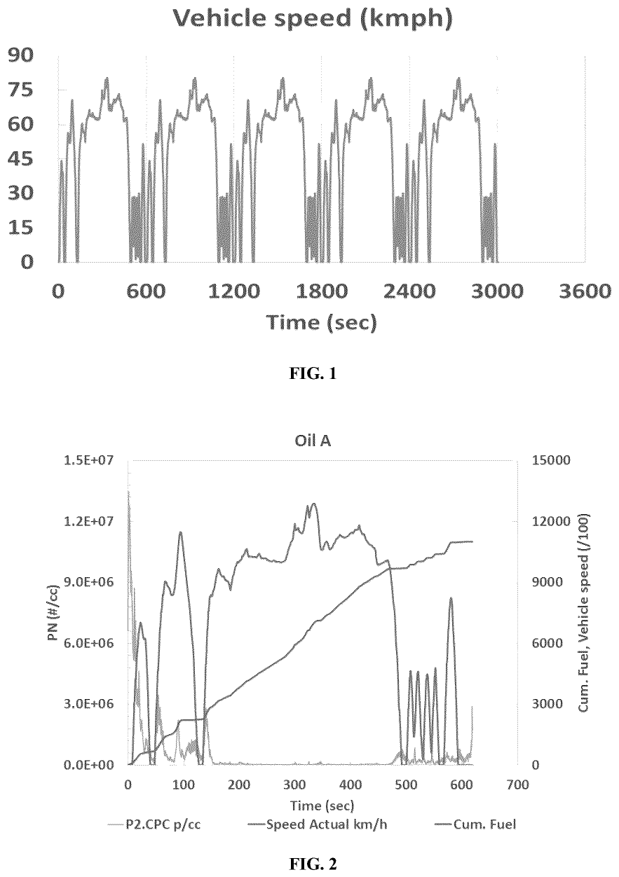

A test protocol based on the US06 drive cycle was used to evaluate the tailpipe particulate emissions for gasoline engines. The protocol is summarized in Table 4 below and started with a cold start US06 cycle (after at least 8 hours soak), and followed by four consecutive warm start US06 cycles (with 1 hour soak between each cycle) with the vehicle speed as set forth in FIG. 1. An exemplary vehicle speed is provided in the Figures. Each test took approximately 6 hours. The testing alternated between runs with Inventive Lubricant A and Comparative Lubricant B. A double oil flush was conducted when oil needed changing for testing. The vehicle for the testing was a 2011 Nissan Juke with a 1.6 L direct injection gasoline engine retrofitted with a GPF filter for the testing herein. The gasoline was EEE fuel.

TABLE 4

| Day | 1 | 2 | 3 | 4 |
|---|---|---|---|---|
| Oil | Oil A | Oil B | Oil A | Oil B |

| | |
|---|---|
| Test protocol | Cold Start US06-soak (1 hour)-US06-soak (1 hour)- |
| | US06 -soak (1 hour)-US06-soak (1 hour)-US06 |
| Note | At the end of each day's test, double flush |
| | of oil sump needs to be conducted and |
| | vehicle is prepared for next day testing |

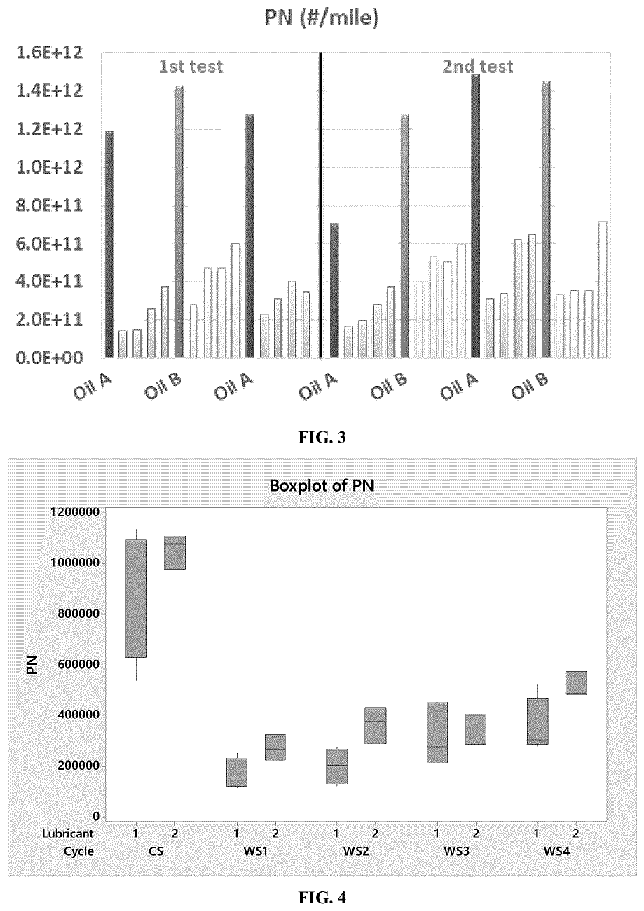

Particle number throughout the drive cycle was measured using the Golden Particle Measurement System (GPMS) as described in the report from the European Commission Directorate-General Joint Research Centre and entitled Particle Measurement Programme (PMP) Light-Duty Inter-laboratory Correlation Exercise (ILCE_LD) Final Report dated 2007 (EUR 22775 EN), which is incorporated herein by reference. Equipment used was an engine exhaust condensation particle counter, model 3790 and an engine exhaust particle sizer, model 3090, both from TSI incorporated. An exemplary single drive cycle instantaneous particle number measurement with a speed trace is shown in FIG. 2 and overall particle number results for each cycle comparing Inventive Lubricant A and Comparative Lubricant B is shown in FIG. 3. A statistical analysis of the results is shown in FIG. 4.

As shown in the graphs, there is a noticeable (and statistically significant) reduction in tailpipe particle number emissions for methods combusting gasoline in engines lubricated with the Inventive Lubricant A as compared to the mixed-metal Comparative Lubricant B. The statistical analysis/box plots, shown in FIG. 4, illustrates the reduction in tailpipe particulate number using the methods with Inventive Lubricant A. On average, methods combusting the gasoline lubricated with Inventive Lubricant A gives lower particle number emission results than gasolines lubricated with mixed-metal Comparative Lubricant B. The reduction in particle number was statistically significant at a 95% confidence level as shown in the Boxplots (where 1 is Inventive Lubricant A, 2 is Comparative Lubricant B, CS refers to a cold start protocol, and WS refers to a warm start protocol).

It is noted that, as used in this specification and the appended claims, the singular forms “a,” “an,” and “the,” include plural referents unless expressly and unequivocally limited to one referent. Thus, for example, reference to “an antioxidant” includes two or more different antioxidants. As used herein, the term “include” and its grammatical variants are intended to be non-limiting, such that recitation of items in a list is not to the exclusion of other like items that can be substituted or added to the listed items

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1 to 4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A method of reducing particulate emissions from a gasoline engine, the method comprising:
combusting a gasoline composition in a gasoline engine, wherein the gasoline engine is lubricated with a lubricating composition including at least about 1800 ppm of calcium and no more than about 100 ppm of magnesium;
wherein a weight ratio of calcium-to-magnesium provided by detergent additives in the lubricating composition is about 200:1 to about 300:1;
wherein the particulate emissions from combustion of the gasoline composition in the gasoline engine, as measured by particle numbers, is reduced as compared to particulate emissions as measured by particle numbers from combustion of the gasoline composition in the gasoline engine when lubricated with a lubricating composition having a mixed calcium and magnesium metal composition with a weight ratio of calcium-to-magnesium provided by detergent additives of about 2:1 to less than about 10:1, and wherein particle number is measured during the combustion of the gasoline composition pursuant to the US06 Drive Cycle; and
further comprising a gasoline particulate filter and wherein the particulate emissions are reduced after one US06 Drive Cycle independent of any prior ash and/or soot accumulation of the gasoline particulate filter.

2. (canceled)

3. (canceled)

4. (canceled)

5. The method of reducing particulate emissions of claim 1, further comprising measuring particulate emissions as particle number while performing an US06 Drive Cycle.

6. The method of reducing particulate emissions of claim 5, wherein particle number is measured pursuant to the Golden Particle Measurement System (GPMS).

7. The method of reducing particulate emissions of claim 1, wherein the gasoline engine is a hybrid-electric engine equipped with a gasoline particulate filter.

8. The method of reducing particulate emissions of claim 1, wherein the lubricating composition includes about 1,800 ppm to about 3,000 ppm of calcium and about 10 ppm to about 100 ppm of magnesium.

9. The method of reducing particulate emissions of claim 1, wherein the lubricating composition includes about 3,000 ppm to about 5,000 ppm of total minerals and wherein about 40 ppm to about 60 weight percent of the total minerals is the calcium and no more than about 1 weight percent of the total minerals is the magnesium.

10. The method of reducing particulate emissions of claim 9, wherein the total minerals of the lubricating composition further include minerals selected from molybdenum, phosphorus, zinc, boron, or combinations thereof.

11. The method of reducing particulate emissions of claim 10, wherein the total minerals of the lubricating composition includes about 1 to about 5 weight percent of molybdenum, about 15 to about 15 weight percent of phosphorus, about 15 to about 30 weight percent of zinc, and about 1 to about 10 weight percent of boron.

12. The method of reducing particulate emissions of claim 1, wherein the lubricating composition further includes one or more additives selected from viscosity index improvers, dispersants, antifoam additives, antioxidants, antiwear additives, friction modifiers, pour point dispersants, detergents, or combinations thereof.

13. The method of reducing particulate emissions of claim 1, wherein the calcium is provided by one or more of a neutral to overbased calcium sulfonate, calcium phenate, or calcium salicylate.

14. The method of reducing particulate emissions of claim 1, wherein the calcium is provided by an overbased calcium sulfonate having a total base number of 200 to 500 mg KOH/g.

15. The method of reducing particulate emissions of claim 14, wherein the magnesium is provided by detergent additives selected from magnesium sulfonate, magnesium phenate, and magnesium salicylate.

16. The method of reducing particulate emissions of claim 1, wherein the gasoline composition includes about 10 to about 200 ppm of a Mannich detergent.

17. The method of reducing particulate emissions of claim 1, further comprising measuring particle number throughout one US06 drive cycle.

18. The method of reducing particulate emissions of claim 1, wherein the gasoline engine is equipped with a gasoline particulate filter.

19. (canceled)

20. The method of reducing particulate emission of claim 1, wherein the lubricating composition includes at least about 2,000 ppm of calcium and no more than about 50 ppm of magnesium.

21. The method of reducing particulate emission of claim 1, wherein the lubricating composition includes at least about 2,000 ppm of calcium and no more than about 25 ppm of magnesium.

22. (canceled)
